(19) United States
(12) Patent Application Publication
(10) Pub. No.: US 2026/0109352 A1
(43) Pub. Date: Apr. 23, 2026

(54) Methods, Data Processing Device and Software for Determining a Deceleration Strategy for a Vehicle

(71) Applicant: Bayerische Motoren Werke Aktiengesellschaft, Muenchen (DE)

(72) Inventors: Andres David ALVAREZ PRADO, Muenchen (DE); Vladislav NENCHEV, Muenchen (DE); Christian RATHGEBER, Muenchen (DE)

(21) Appl. No.: 19/121,908

(22) PCT Filed: Oct. 13, 2023
(86) PCT No.: PCT/EP2023/078571

§ 371 Date: Apr. 17, 2025

(30) Foreign Application Priority Data
Oct. 18, 2022 (DE) 10 2022 127 343.1

(51) Int. Cl. B60W 30/14; B60W 30/18; B60W 30/182; B60W 40/10

(52) U.S. Cl. CPC B60W 30/146; B60W 30/18072; B60W 30/18136; B60W 30/182; B60W 40/1005; B60W 2720/106

(57) ABSTRACT

A method for determining a deceleration strategy for a vehicle includes determining a target position located on a route section ahead together with a target speed that the vehicle should have when it reaches the target position, wherein the target speed is lower than a current speed of the vehicle, and determining a reference trajectory for the vehicle that provides for reaching the target position at the target speed. The reference trajectory is determined based on analytical functions for at least two deceleration modes from a list including a coasting mode, an overrun mode, a recuperation mode and active braking. The analytical functions for each of the at least two deceleration modes indicate a speed and/or a distance travelled as a function of a time variable. Determining the reference trajectory includes determining one or more changeover times between the at least two deceleration modes.

### BACKGROUND AND SUMMARY

The invention relates to methods and to a data processing device for determining a deceleration strategy for a vehicle. The invention furthermore relates to software for carrying out such methods by way of a data processing device and to a computer-readable storage medium on which such software is stored.

Modern automated driving functions intervene actively in the transverse and longitudinal guidance of the vehicle. For this purpose, use is often made of trajectory planning, which plans the movement of the vehicle over several seconds on a predictive basis. The focus when implementing trajectory planning is usually on comfort and safety.

The prior art also discloses efforts that have been made to implement energy-efficient trajectory planning for automated driving, cf. for example: Terwen, Stephan: Vorausschauende Längsregelung schwerer Lastkraftwagen [Predictive longitudinal control for heavy goods vehicles], Karlsruher Institut für Technologie, PhD, 2010; Radke, Tobias: Energieoptimale Längsführung von Kraftfahrzeugen durch Einsatz vorausschauender Fahrstrategien [Energy-optimized longitudinal guidance of motor vehicles using predictive driving strategies], Karlsruher Institut für Technologie, PhD, 2013; Yan et al: Eco-Coasting Strategies Using Road Grade Preview: Evaluation and Online Implementation Based on Mixed Integer Model Predictive Control, arXiv, 2015; A Sciarretta, Giovanni de Nunzio, L Leon Odeja, Optimal Ecodriving Control: Energy-Efficient Driving of Road Vehicles as an Optimal Control Problem, IEEE Control Systems Magazine, Institute of Electrical and Electronics Engineers, 2015; Saerens, Bart: Optimal Control Based Eco-Driving, Katholieke Universiteit Leuven, PhD, 2012. Most of these suggestions use computationally intensive optimization-based approaches to minimize fuel consumption or energy consumption over a time horizon. To do so, they require a detailed model of the specific drivetrain, of the fuel consumption and/or of the battery state of charge.

Furthermore, the prior art already contains solutions for predictively adapting the longitudinal dynamics of a motor vehicle to specific situations in route sections ahead. Specifically with reference to a deceleration process of a vehicle, solutions based on a multistage deceleration strategy have been proposed. By way of example, laid-open patent applications DE 10 2014 215 673 A1 and DE 10 2015 205 371 A1 from the applicant each disclose a driver assistance system that ascertains a single-stage or multistage deceleration strategy upon recognizing an event ahead requiring a speed reduction and, following confirmation by the driver, initiates the automatic implementation of the deceleration strategy, wherein the deceleration stages of the deceleration strategy are defined as a function of predefined parameters. DE 10 2017 205 134 A1 from the applicant describes a deceleration assistance system for a motor vehicle having an electronically controllable automatic transmission and an electronic control unit for controlling upward and downward gear shifts in the transmission. In this case, a deceleration strategy for reducing the speed to a target speed at the location of an event ahead is ascertained, wherein the deceleration strategy comprises carrying out an automated shifting-down process and is also carried out without any operating element being actuated by the driver. Some of the electric vehicles manufactured by the applicant are also already equipped with a predictive situation-specific drive function that enables what is known as adaptive deceleration or adaptive recuperation. “Recuperation” should be understood here generally to mean the recovery and battery-based storage of electrical energy from (previously electrically generated) kinetic energy of an electric vehicle, for example in a braking process.

Against this background, one object of the present invention is to specify a method for determining a deceleration strategy for an automated deceleration process of a vehicle that enables particularly computationally efficient implementation and is able to be used as far as possible universally, that is to say for example able to be combined with conventional longitudinal guidance controllers.

The object is achieved by the subjects of the independent patent claims. Advantageous embodiments are given in the dependent claims.

It is pointed out that additional features of a patent claim dependent on an independent patent claim may form a specific invention that is independent of the combination of all of the features of the independent patent claim without the features of the independent patent claim or only in combination with some of the features of the independent patent claim, which invention may form the subject matter of an independent patent claim, of a divisional application or of a subsequent application. This applies analogously to technical teaching described in the description, which teaching may form an invention that is independent of the features of the independent patent claims.

A first aspect of the invention relates to a method for determining a deceleration strategy for a vehicle.

The vehicle may be a motor vehicle. The term motor vehicle should be understood here to mean a land vehicle moved by mechanical force, without being tied to rails. A motor vehicle in this sense may be designed for example as a passenger car, motorcycle or traction machine. By way of example, the vehicle may be a vehicle driven by way of an internal combustion engine, an electrically driven vehicle or a vehicle having a hybrid drive consisting of an internal combustion engine and an electric drive.

One step of the method is that of determining a target position that lies on a route section ahead together with a target speed at which the vehicle should be when it reaches the target position, wherein the target speed is less than a current speed of the vehicle.

By way of example, a control device of the vehicle may use map data and/or data from a surroundings sensor system to predictively recognize a target situation, such as entering a bend or a roundabout, or a traffic sign that indicates a speed limit that requires the vehicle to slow down. To recognize such target situations, it is possible to use methods known per se for fusing map data and/or surroundings sensor data, including all artificial intelligence methods known per se.

By way of example, a most probable vehicle path may first be determined in a map. This may take place, for example, on the basis of active route guidance or via a separate calculation on the basis of the vehicle position in connection with map attributes in the surroundings of the vehicle (for example, road classes, direction change angles and the like) and/or a driver behavior interpretation, which evaluates, for example, the activation of an indicator or moving to an exit lane with regard to a most probable vehicle path. Characteristics such as road types and bend radii and relevant situations such as the start of speed limits, red lights, bends, intersections or roundabouts may then be extracted from map data and/or surroundings sensor data along the predicted most probable vehicle path. Such a situation ahead may then be determined as the next target situation together with an associated target position and target speed.

A further step of the method is that of ascertaining a reference trajectory for the vehicle, wherein the reference trajectory is compatible with reaching the target position at the target speed. This is understood to mean that the vehicle, when it moves according to the reference trajectory, will be at the target speed when it reaches the target position.

The reference trajectory may in this case relate to the longitudinal guidance of the vehicle, that is to say, for example, describe a longitudinal movement of the vehicle along a path from a current vehicle position to the target position (the path not having to run linearly per se, but rather also possibly being curved). By way of example, the reference trajectory may comprise a time-dependent distance, such as an indication of a distance traveled up to a respectively considered point in time in the direction of the target position. Moreover, the reference trajectory may indicate a time-dependent longitudinal speed and/or a time-dependent longitudinal acceleration of the vehicle.

According to the method, the reference trajectory is ascertained based on respective analytical functions for at least two, preferably at least three deceleration modes from the list comprising a sailing mode, a drag mode, a recuperation mode and active braking. In this case, the analytical functions for each of the at least two, preferably at least three deceleration modes each indicate a speed and/or a distance traveled, for example, a current distance from the starting point of the deceleration process, as a function of a time variable.

A sailing mode is understood to mean completely or substantially traction-free coasting of the vehicle. In the case of a vehicle having a combustion engine, this operating state is characterized, for example, by an interruption of traction between the transmission and the (possibly deactivated) engine.

With respect to a vehicle having an electric drive machine, which may not have a transmission at all, sailing mode in the context of this document may be understood to mean an operating state in which the electric drive machine does not generate any mechanical drive torque and is also not in a generator mode (recuperation mode), that is to say does not convert kinetic energy into electrical energy. In other words, the electric drive machine, in sailing mode, converts no or substantially no electrical energy into mechanical energy or vice versa. By way of example, the electric drive generates no or at most a very small braking torque in sailing mode. The electric drive machine is accordingly able, for example, to rotate completely freely in sailing mode and bring about comparatively low deceleration at most as a result of the friction of brushes (where present) or the like.

(Engine) drag mode, which is often also referred to as engine braking, should be understood to mean a driving state in which there is traction between the transmission and the engine that provides for effective deceleration of the vehicle even without active braking.

A recuperation mode is distinguished, as already mentioned at the outset, by the recovery of electrical energy from kinetic energy using an electric drive machine of a vehicle. This makes it possible to achieve a considerable deceleration effect.

Active braking is carried out, for example, by way of a dedicated braking system, usually with a settable braking intensity.

According to the invention, provision is furthermore made for ascertaining the reference trajectory to comprise ascertaining one or more changeover times between the at least two, preferably at least three deceleration modes based on the analytical functions. The changeover times may in this case be ascertained based on a parametric optimization with regard to the changeover times.

According to one embodiment, ascertaining the reference trajectory furthermore comprises determining a braking manipulated variable effective during braking mode. It is possible to ascertain a temporal profile of the braking manipulated variable, for example by minimizing a cost function.

According to one embodiment, the analytical functions may be given as closed mathematical expressions with the time variable and multiple function parameters that characterize one or more types of driving resistances. By way of example, the analytical functions with the time variable and the function parameters may be stored in software and called when the method is carried out. The driving resistances may comprise, for example, an air resistance and/or a rolling resistance, which is preferably dependent on a road incline or other predictive road information, these resistances contributing to the deceleration of the vehicle.

According to one variant embodiment, the function parameters may furthermore comprise one or more deceleration manipulated variables for one or more of the deceleration modes. In this case, the deceleration manipulated variables may be assumed to be constant over time, for example, during a respective deceleration phase in which a respective deceleration mode is active. By way of example, one deceleration manipulated variable may characterize a deceleration in drag mode of the vehicle. Another deceleration manipulated variable may characterize a deceleration in recuperation mode. Yet another deceleration manipulated variable may characterize a deceleration caused by active braking.

According to one embodiment, one or more of the analytical functions that indicate the distance traveled as a function of the time variable for the at least two deceleration modes may be written in the following form:

$$s ( t ) = A ln ( {tan ( B t + C )}^{2} + 1 ) + D$$

where s denotes distance, which depends on the time variable t. A, B, C and D are function parameters that are constant over time. The function parameters A, B, C and D may be derived for example from function parameters concerning driving resistances or deceleration manipulated variables for the different deceleration modes or comprise same. It should be borne in mind here that the expression s(t) given above may in each case adopt a different form for the different deceleration modes. The function parameters A, B, C and D for the different functions s(t) that are assigned to the different deceleration modes may differ from one another. Specific expressions of the function parameters A, B, C and D for functions s(t) for a sailing mode, a drag mode and active braking are given further below with reference to one exemplary embodiment. The dependency of the driving resistances and deceleration manipulated variables of the different deceleration modes becomes clear therein.

According to a further embodiment, which may be combined with the embodiment described above concerning a specific form of the analytical expression for the distance, one or more of the analytical functions that give the speed dependency on the time variable for the at least two deceleration modes may be written in the following form:

$$v ( t ) = E tan ( F t + G ) ,$$

where v is speed, t is the time variable and E, F and G are constant function parameters. The explanations given above regarding the function parameters A, B, C and D apply analogously to the function parameters E, F and G. The function parameters E, F and G of the speed functions for the different deceleration modes may also differ from one another.

It is also within the scope of the invention for the one or more changeover times to be ascertained based on a parametric optimization in the course of minimizing a cost function.

According to one embodiment, the cost function in this case comprises a sum of multiple time integrals, wherein each of the integrals extends temporally over a respective deceleration phase that is assigned to a respective one of the at least two, preferably at least three deceleration modes. The one or more changeover times to be ascertained in this case form upper and lower integral bounds of the integrals. Further integral bounds may be formed by a start time and an end time of the overall deceleration process.

According to one variant embodiment, the cost function under the integrals has a respective time-dependent cost term for the at least two deceleration phases that applies costs to a loss of kinetic energy that has taken place up to the time in question in comparison to an initial kinetic energy that the vehicle has or had at the start of the deceleration. This cost term has the advantageous effect that the vehicle utilizes the initially stored kinetic energy as well as possible during the deceleration to reach the target position quickly. This is because, since the cost term provides a “reward” when the vehicle economizes for as long as possible with the kinetic energy or, on the contrary, provides a “penalty” when the kinetic energy is dissipated excessively quickly, the vehicle ultimately continues to travel as long as possible at a relatively high speed to the target position.

According to one development, provision may also be made in the cost function for a cost term that applies costs to active braking, such as a cost term that comprises a square of a braking manipulated variable, for instance a braking deceleration. Such a term may ultimately prevent excessively abrupt braking, for example, shortly before reaching the target position, and thus promote comfort and safety.

The sub-aspect, described above as one possible embodiment of the first aspect of the invention, concerning a cost term that applies costs to a loss of kinetic energy that has taken place up to the time in question in comparison to an initial kinetic energy may also be implemented independently of the features described further above of the method according to the first aspect of the invention concerning ascertaining the reference trajectory based on analytical functions.

Accordingly, as an independent second aspect of the invention, a method for determining a deceleration strategy for a vehicle is specified, wherein the method in particular comprises the following steps: determining a target position that lies on a route section ahead together with a target speed at which the vehicle should be when it reaches the target position, wherein the target speed is less than a current speed of the vehicle; and ascertaining a reference trajectory for the vehicle that makes provision to reach the target position at the target speed. In this case, the reference trajectory has at least two deceleration phases in which the vehicle is operated in each case in a different deceleration mode from the list comprising a sailing mode, a drag mode, a recuperation mode and active braking. Ascertaining the reference trajectory comprises ascertaining one or more changeover times between the at least two deceleration modes, wherein the one or more changeover times is or are ascertained based on minimizing a cost function. The cost function comprises a sum of multiple time integrals, wherein each of the integrals extends temporally over a respective one of the deceleration phases, wherein the one or more changeover times form upper or lower integral bounds of the integrals, and wherein the cost function under the integrals has a respective time-dependent cost term for the at least two deceleration phases that applies costs to a loss of kinetic energy that has taken place up to the time in question in comparison to an initial kinetic energy that the vehicle has at the start of the deceleration.

The method according to the second aspect of the invention may be combined with all of the variant embodiments of the method according to the first aspect of the invention and vice versa.

According to one embodiment of the method according to the first or second aspect of the invention, provision is made for the time-dependent cost term to comprise a square of a difference between a kinetic energy at the time in question and the initial kinetic energy. It has turned out that the selection of a cost term of this type is particularly advantageous both with regard to computationally efficient solvability of the optimization problem and with regard to the characteristics of the resulting reference trajectory in terms of comfort and safety.

Accordingly, in one variant embodiment, the cost function may be given in the following form:

$$J = \frac{1}{2} {\int }_{t}^{t} \text{?} ( {w}_{u} {u}^{2} + {w}_{kin} {( {E}_{kin} ( v ) - {E}_{kin} ( {v}_{0} ) )}^{2} ) dt$$

$$\text{?} \text{indicates text missing or illegible when filed}$$

in which J denotes the costs, t₀ denotes the starting time of the deceleration process, tᵣ denotes the end time of the deceleration process (at which the target position is reached), Eₖᵢₙ(v) denotes the kinetic energy at the time t, Eₖᵢₙ(v₀) denotes the kinetic energy at the starting time t₀ and u denotes a deceleration manipulated variable, wherein different variables u may apply for drag mode, recuperation mode or braking mode. The factors wᵤ and wₖᵢₙ are constants.

The second term under the integral of the cost function J is the cost term, mentioned further above, concerning kinetic energy. The first term under the integral applies costs for example to an active braking process or a drag mode.

Since the first term applies costs to active braking, it contributes to determining a deceleration strategy that is as energy-efficient as possible, since energy has to be expended for active braking by way of a braking system.

As mentioned above, in the above general expression for the cost function J, the variable u, depending on the deceleration phase in question, represents, for example, an active braking manipulated variable, a deceleration manipulated variable in drag mode or a deceleration manipulated variable in recuperation mode. The time integral may specifically be divided into multiple sub-integrals for different deceleration phases with corresponding temporal interval limits, such as into a sailing phase that extends over a first time interval from to up to a first changeover time tₛ₁, a drag phase that extends over a second time interval from the first changeover time tₛ₁ up to a second changeover time tₛ₂, and an active braking phase that extends over a third time interval from the second changeover time tₛ₂ up to the end time t₁. In this exemplary division into three deceleration phases, the deceleration manipulated variable, generally given above as u, needs to be replaced specifically as follows for the individual sub-integrals:

$$u = \{ \begin{matrix}0 , & [ {t}_{0} , {t}_{{s}_{1}} ) \\ {a}_{drag} ( t ) , & [ {t}_{{s}_{1}} , {t}_{{s}_{2}} ) \\ {u}_{brake} ( t ) , & [ {t}_{{s}_{2}} , {t}_{f} ]\end{matrix}$$

Accordingly, no deceleration manipulated variable acts in the sailing phase (u=0), the deceleration manipulated variable a_{drag}(t) acts in the drag phase and another deceleration manipulated variable u_{brake}(t) in turn acts in the subsequent active braking phase. Clarification is given below, in the description of one exemplary embodiment by way of example, as to what form the sub-integrals may adopt for the different deceleration phases.

According to one embodiment of the first aspect of the invention or of the second aspect of the invention and in accordance with the exemplary variant embodiment described above, the reference trajectory comprises a sailing phase, in which the vehicle drives in sailing mode, and at least one further deceleration phase at a time after the sailing phase, in which the vehicle drives in a drag mode or recuperation mode or is actively braked. In other words, the reference trajectory may thus be determined in such a way that it has a drag phase, recuperation phase and/or braking phase at a time after a sailing phase. According to one exemplary embodiment, provision may in particular be made for the vehicle to first sail, and then be decelerated in a drag mode and finally braked actively to the target speed. A sequence of the corresponding deceleration phases may be specified when ascertaining the trajectory, in particular when solving the optimization problem with regard to the changeover times. According to one embodiment of the method according to the first or second aspect of the invention, the method furthermore comprises ascertaining a target trajectory for the vehicle as a function of the ascertained reference trajectory and generating an actuator input for longitudinal guidance of the vehicle as a function of the target trajectory.

By way of example, the target trajectory may be planned cyclically in each case over a comparatively short planning horizon of a few seconds, such as 6 seconds. A planning horizon of the target trajectory, in any case at the start of the overall deceleration process of the vehicle, may be shorter than a planning horizon of the reference trajectory.

The target trajectory may be ascertained for example by way of an optimization, such as a quadratic optimization, with regard to further criteria, concerning for example safety and comfort of the vehicle or its occupants. In this case, the ascertained target trajectory may for example comprise state variables of the same kind as the reference trajectory, such as for instance a time-dependent distance traveled, a time-dependent speed, a time-dependent acceleration and/or a time-dependent jerk.

The reference trajectory may for example be taken into consideration as a reference when calculating the target trajectory, such that a cost function to be minimized in the course of determining the target trajectory applies costs to deviations between target trajectory variables and reference trajectory variables. By way of example, the cost function may comprise one or more terms that each apply costs to a square of a difference between a target trajectory variable (to be determined) and a corresponding reference trajectory variable. This may concern the trajectory variables path, speed and acceleration.

It is also possible to take the reference trajectory into consideration when calculating the target trajectory such that a time-dependent speed profile in accordance with the reference trajectory is used as an upper limit in the course of an optimization in order to determine a speed in accordance with the target trajectory speed. As an alternative or in addition, the reference trajectory may be taken into consideration when determining the target trajectory such that a temporal profile of a braking manipulated variable resulting from the reference trajectory is used as a limit in the course of an optimization in order to determine an acceleration or deceleration in accordance with the target trajectories. Such a restriction provided by the reference trajectory variables does not have to be a hard restriction here according to some variant embodiments, but rather may be softened, for example, by the use of slack variables.

Generating the actuator input may, for example, comprise generating an acceleration specification for a longitudinal guidance actuator system of the vehicle as a function of the target trajectory. For this purpose, the target trajectory may be transferred to a trajectory follow-up controller that outputs an acceleration specification to the longitudinal guidance actuator system, for example to a drive and/or a braking system of the vehicle, as a function of the target trajectory and of information about measured interfering variable influences.

It should be borne in mind that ascertaining a separate target trajectory (and also possibly a trajectory follow-up controller) is an optional intermediate step. Embodiments in which the reference trajectory itself is used as target trajectory and, as such, is output to a controller or else directly for forwarding to a trajectory follow-up controller or to a longitudinal guidance actuator system are also conceivable. This is possible, for example, when the reference trajectory indicates an acceleration and the controller or the actuator system are configured to process this acceleration as a target acceleration.

More generally speaking, a method according to the first or second aspect of the invention may thus furthermore comprise generating an actuator input for longitudinal guidance of the vehicle as a function of the reference trajectory.

If the reference trajectory is implemented by way of a longitudinal guidance actuator system of the vehicle or, more generally speaking, processed further by a control loop, the method according to the first or second aspect of the invention may be carried out cyclically by feeding back in each case a current state (for example, measured by way of an odometer) of the control variable, such as a current actual speed or a current actual acceleration or an actual distance traveled, to a reference trajectory planner, which carries out the steps of the method for determining the reference trajectory. This may then recalculate the reference trajectory based on the current information. In this case, in accordance with one variant embodiment described above, a separate target trajectory planner may be switched between the reference trajectory planner and the control loop and for its part again determines a target trajectory with its own, possibly comparatively short planning horizon of, for example, a few seconds as a function of current actual variables and the reference trajectory. The control loop may for example, as mentioned above, comprise a trajectory follow-up controller and a longitudinal guidance actuator system.

A third aspect of the invention is a data processing device that is configured to carry out a method according to the first or second aspect of the invention. Embodiments of the data processing device according to the invention may accordingly correspond to the embodiments of the method according to the invention that are described in this document and vice versa. The data processing device may comprise one or more processors, such as one or more controllers or microcontrollers, which are configured to carry out the method.

A fourth aspect of the invention is software comprising commands that, when the software is executed by a data processing device, prompt the data processing device to carry out a method according to the first or second aspect of the invention. The software may accordingly be executed on one or more processors that form the data processing device (or parts thereof) according to the third aspect of the invention that are contained in the data processing device. In this case, a computer program contained in the software may also be divided into multiple separate subroutines that may each be executed on different computers (such as multiple separate processors), which may be spatially remote from one another.

A fifth aspect of the invention is a computer-readable storage medium on which software according to the fourth aspect of the invention is stored.

In accordance with some embodiments described above and below, the invention is based on the concept of ascertaining a safe, comfortable and energy-efficient reference trajectory for decelerating a vehicle to a target speed at a given target position with multiple different deceleration phases in a computationally efficient and thereby real-time-capable manner. A parametric optimization as part of a hybrid optimal control (HOC) problem may be used here to determine expedient changeover times between different deceleration modes. It has turned out here that, by making targeted simplifying assumptions, for example, concerning the fact that respective deceleration manipulated variables are constant over time in the different deceleration modes, and by skillfully selecting a cost function for the optimization, it is possible to achieve a particularly computationally efficient solution that leads to reference trajectories having satisfactory characteristics.

The reference trajectory variables, in the methods proposed here, may be kept comparatively generic and may indicate a temporal profile of path traveled, speed, acceleration and/or jerk, in contrast for instance to specific drive specifications such as a torque, which would be highly dependent on particularities of the drive machine. The proposed reference trajectory planning is therefore able to be combined easily with conventional and possibly pre-existing controller architectures for different vehicles. Existing target trajectory planners may thus be enhanced easily with the reference trajectory planner proposed here and do not have to be replaced as a whole. By way of example, a corresponding reference trajectory planner may be connected upstream of an existing target trajectory planner, the latter being able to use the reference trajectory variables as reference variables or limits as part of its conventional optimization. In this case, for example, comfort and safety requirements placed on the trajectory planning that the existing target trajectory planner has already taken as a basis continue to be taken into consideration.

The proposed reference trajectory planning may, according to some embodiments, be independent of a topology of the drivetrain of the vehicle. In this case, for example, a detailed drivetrain model and fuel consumption model may be dispensed with. The calibration effort for different vehicle variants is thus reduced.

The invention will now be explained in more detail based on exemplary embodiments and with reference to the accompanying drawings. In this case, the features and combinations of features mentioned above or below in the description and/or shown on their own in the drawings may be used not only in the respectively indicated combination but also in other combinations or on their own without departing from the scope of the invention.

### BRIEF DESCRIPTION OF THE DRAWINGS

FIG. 1 illustrates, by way of example and schematically, a deceleration-relevant target situation ahead of a vehicle in the form of a road sign indicating a speed limit.

FIG. 2 illustrates, by way of example and schematically, a method sequence for determining a deceleration strategy for a vehicle according to a first aspect of the invention.

FIG. 3 illustrates, by way of example and schematically, a method sequence for determining a deceleration strategy for a vehicle according to a second aspect of the invention.

FIG. 4 illustrates, by way of example and schematically, a model of the vehicle longitudinal guidance as a switching system.

FIG. 5 illustrates time-dependent and location-dependent reference trajectory variables that have been determined using a two-dimensional parametric optimization.

FIG. 6 illustrates, by way of example and schematically, the determination of changeover times based on a speed/distance graph.

FIG. 7 illustrates, by way of example and schematically, a system for controlling the longitudinal guidance of a vehicle.

### DETAILED DESCRIPTION OF THE DRAWINGS

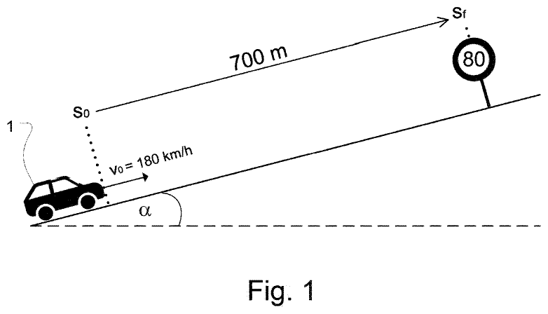

FIG. 1 schematically shows an exemplary driving situation involving a vehicle 1 that is currently, at a starting time to, located at a starting position so and is moving constantly at a starting speed of v₀=180 km/h.

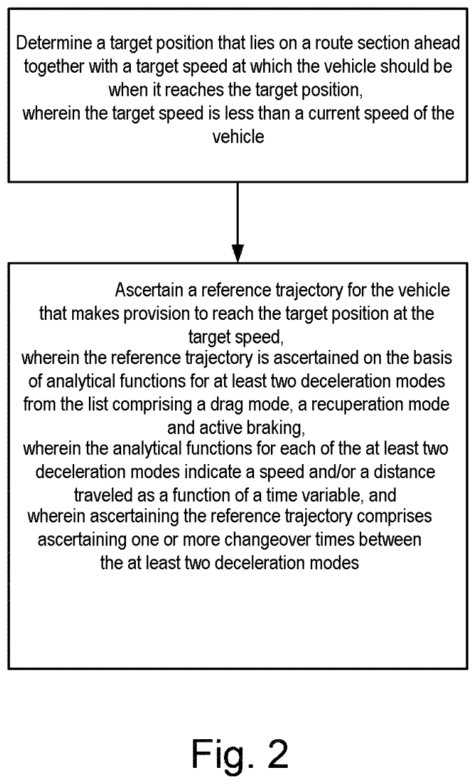

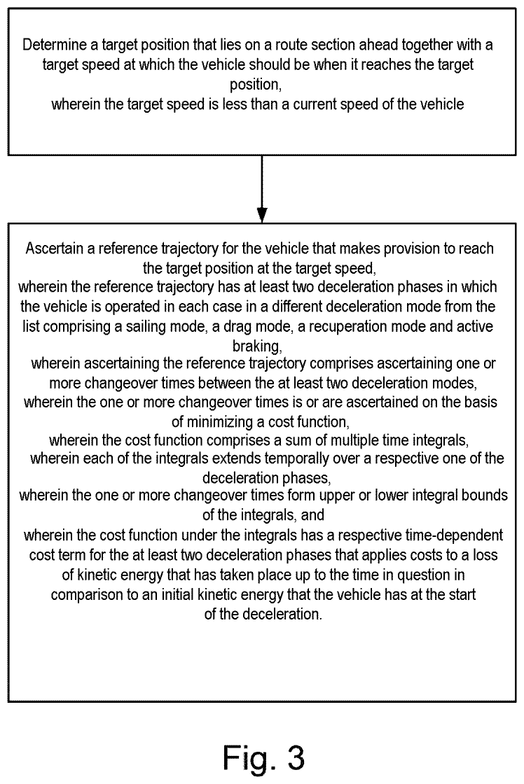

FIGS. 2 and 3 each show a method sequence for determining a deceleration strategy for a vehicle.

The method sequences according to FIGS. 2 and 3 are explained below by way of example with reference to the driving situation illustrated in FIG. 1. In this case, a data processing device, for example, in the form of one or more controllers of the vehicle 1, carries out specific steps, which are consistent with the two method sequences according to FIG. 2 and FIG. 3, in real time.

In a first step, which the method sequences according to FIG. 2 and FIG. 3 have in common, a target position s_{f} that lies on a route section ahead, together with a target speed v₁ of 80 km/h at which the vehicle 1 should be when it reaches the target position s_{f}, are determined. By way of example, the target position s_{f}, together with the target speed v_{f}, is taken from a digital map in the form of information about a speed limit, wherein GPS data may be used to determine that the target position s_{f} is 700 m away from the current vehicle position s₀. Since the target speed v_{f} is less than the starting speed v₀, it is necessary to slow the vehicle 1 down. A suitable deceleration strategy for the longitudinal guidance of the vehicle therefore needs to be ascertained.

In the exemplary embodiment, the vehicle 1 is a vehicle having an internal combustion engine and that supports a sailing mode, a drag mode (engine braking) and active braking as different deceleration modes. The deceleration strategy to be determined should accordingly indicate the time for which or the distance over which the vehicle 1 should sail, drag and finally be actively braked in order to reach the target position s_{f} at the target speed v_{f}.

When ascertaining the deceleration strategy, a road incline, illustrated schematically in FIG. 1, with an angle of incline α should be taken into consideration, since the steepness of the road contributes to decelerating the vehicle 1. In the exemplary embodiment, the angle of incline α is assumed to be constant over the entire distance from the starting position to the target position for the sake of improved understanding. However, it is also possible to take into consideration angles of incline that may be different in sections.

In a further step, a reference trajectory is determined for the vehicle 1, the reference trajectory being compatible with reaching the target position s_{f} at the target speed v_{f}.

One possible procedure for ascertaining the reference trajectory is explained in more detail below. This exemplary embodiment is in accordance with the respective second method step according to both FIG. 2 and FIG. 3.

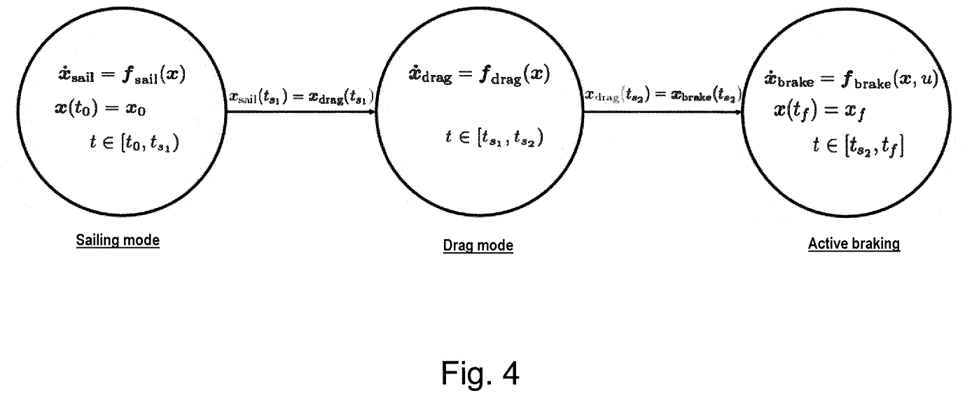

As a basis for ascertaining the reference trajectory, the vehicle 1, together with the constraints described above, is modeled as a switching system. This is illustrated schematically in FIG. 4.

In this case, the vehicle longitudinal movement is described by a state vector x(t) dependent on a time variable t, said state vector comprising a path s(t), a speed v(t) and an acceleration a(t) as vector components. The state vector satisfies the starting condition x(t₀)=x₀, wherein the starting state vector x₀ comprises the starting variables s₀ and v₀ already introduced further above.

It is specified in the exemplary embodiment that the vehicle 1 is in a sailing mode in a first deceleration phase, namely during a time interval from the starting time t₀ up to a first changeover time tₛ₁. In this case, the vehicle 1 is subject, in the first deceleration phase, to system dynamics, which are expressed formally in the equation \dot{x}ₛₐᵢₗ=fₛₐᵢₗ(x).

At the first changeover time tₛ₁, a changeover takes place from sailing mode to drag mode. Drag mode lasts during a time interval from the first changeover time tₛ₁ up to the second changeover time tₛ₂. During this second deceleration phase, the vehicle 1 is subject to system dynamics in accordance with the equation \dot{x}_{drag}=f_{drag}(x).

At the second changeover time tₛ₂, a changeover takes place from drag mode to an active braking mode. Active braking lasts during a time interval from the second changeover time tₛ₂ up to the end time tᵣ of the overall deceleration process. During this third deceleration phase, the vehicle 1 is subject to system dynamics in accordance with the equation \dot{x}_{brake}=f_{brake}(x, u), with the braking manipulated variable u.

At the changeover times, the continuity conditions xₛₐᵢₗ(tₛ₁)=x_{drag}(tₛ₁) and x_{drag}(tₛ₂)=x_{brake}(tₛ₂) apply.

Proceeding from this, the reference trajectory, together with the changeover times, may be determined as a solution to the following hybrid optimal control problem in the course of a parametric optimization:

$$\begin{matrix}min \text{?} & J = \int \text{?}\end{matrix} ( {w}_{u} {u}^{2} + {{w}_{kin} ( {E}_{kin} ( v ) - {E}_{kin} ( {v}_{0} ) )}^{2} ) dt$$

$$\begin{matrix}\begin{matrix}s . t . & {\dot{x}}_{sail} ( t ) =\end{matrix} {f}_{sail} ( {x}_{sail} , u ) & t ∈\end{matrix} [ {t}_{0} , {t}_{{s}_{1}} )$$

$$\begin{matrix}{\dot{x}}_{drag} ( t ) = {f}_{drag} ( {x}_{drag} , u ) & t ∈\end{matrix} [ {t}_{{s}_{1}} , {t}_{{s}_{2}} )$$

$$\begin{matrix}{\dot{x}}_{brake} ( t ) = {f}_{brake} ( {x}_{brake} , u ) & t ∈\end{matrix} [ {t}_{{s}_{2}} , {t}_{f} ]$$

$$u = \{ \begin{matrix}0 , & [ {t}_{0} , t \text{?} ) \\ {a}_{drag} ( t ) , & [ t \text{?} , t \text{?} ) \\ {u}_{brake} ( t ) , & [ {t}_{{s}_{2}} , {t}_{f} ]\end{matrix}$$

$${x}_{sail} ( {t}_{0} ) = {x}_{0}$$

$${x}_{sail} ( {t}_{{s}_{1}} ) = ( {x}_{drag} ( t \text{?} ) ; {x}_{drag} ( t \text{?} ) = {x}_{brake} ( t \text{?} )$$

$${x}_{brake} ( {t}_{f} ) = {x}_{f}$$

$$0 \leq {u}_{brake} \leq {u}_{max}$$

$${t}_{0} \leq {t}_{{s}_{1}} \leq t \text{?} \leq {t}_{f}$$

$$\text{?} \text{indicates text missing or illegible when filed}$$

In accordance therewith, the changeover times tₛ₁, tₛ₂ and the end time tᵣ need to be determined such that the cost function J is minimal. In this case, the starting, continuity and end conditions given above and the restrictions given above with regard to an order of the different times must be complied with. There is also a restriction on the braking manipulated variable u_{brake} whereby this must not exceed a maximum braking deceleration uₘₐₓ.

The integral of the cost function J may be written as a sum of three sub-integrals for the three deceleration phases with the corresponding starting, end and changeover times as temporal interval bounds. In this case, the deceleration manipulated variable, given generally as u in the above integral expression, for the individual sub-integrals needs to be replaced specifically in accordance with the rule given above. Accordingly, no deceleration manipulated variable acts in the sailing phase (u=0), the deceleration manipulated variable a_{drag}(t) acts in the drag phase and another deceleration manipulated variable u_{brake}(t) in turn acts in the subsequent active braking phase.

The cost function J under the integrals has a time-dependent cost term for each deceleration phase that applies costs to a loss of kinetic energy Eₖᵢₙ(v) that has taken place up to the time in question in comparison to an initial kinetic energy Eₖᵢₙ(v₀) that the vehicle has or had at the start of the deceleration. Specifically, this cost term comprises a square of the difference between the kinetic energy Eₖᵢₙ(v) at the time in question and the initial kinetic energy Eₖᵢₙ(v₀), with a constant pre-exponential factor wₖᵢₙ.

The equation for the system dynamics in sailing mode may be written as follows:

$$\begin{matrix}{\dot{x}}_{sail} = [ \begin{matrix}{s}_{sail} \text{?} \\ {v}_{sail} \text{?}\end{matrix} ] \\ = [ \begin{matrix}{v}_{sail} \\ - \frac{ρ {A}_{f} {c}_{d}}{2 m} {v}_{sail}^{2} - g sin ( α ) - {c}_{r} g cos ( α )\end{matrix} ] \\ = [ \begin{matrix}{v}_{sail} \\ - {a}_{air} {v}_{sail}^{2} - {a}_{sail}\end{matrix} ]\end{matrix}$$

$$\text{?} \text{indicates text missing or illegible when filed}$$

in which aₐᵢᵣ=−(ρ A_{f} c_{d}/(2 m) denotes an air resistance coefficient, cᵣ denotes a rolling resistance coefficient and g represents gravitational acceleration. The following has been replaced in the last step:

aₛₐᵢₗ=g sin(α)−cᵣ g cos(α), with the road angle of incline α, which is assumed here to be constant over the entire deceleration distance.

The equation for the system dynamics in drag mode may be written as follows:

$$\begin{matrix}{\dot{x}}_{drag} = [ \begin{matrix}{\dot{s}}_{drag} \\ {\dot{v}}_{drag}\end{matrix} ] \\ = [ - \begin{matrix}{v}_{drag} \\ \frac{ρ {A}_{f} {c}_{d}}{2 m} {v}_{drag}^{2} - g sin ( α ) - {c}_{r} g cos ( α ) - {a}_{drag}\end{matrix} ] \\ = [ \begin{matrix}{v}_{drag} \\ - {a}_{air} {v}_{drag}^{2} - {a}_{sail} - {a}_{drag}\end{matrix} ]\end{matrix}$$

in which a_{drag} denotes a drag deceleration caused by the effect of engine braking.

The equation for the system dynamics during active braking may be written as follows:

$$\begin{matrix}{\dot{x}}_{brake} = [ \begin{matrix}{s}_{brake} \text{?} \\ {v}_{brake} \text{?}\end{matrix} ] \\ = [ - \begin{matrix}{v}_{sail} \\ \frac{ρ {A}_{f} {c}_{d}}{2 m} {v}_{drag}^{2} - g sin ( α ) - {c}_{r} g cos ( α ) - {a}_{drag}\end{matrix} ] \\ = [ \begin{matrix}{v}_{brake} \\ - {a}_{air} {v}_{brake}^{2} - {a}_{sail} - {u}_{brake}\end{matrix} ]\end{matrix}$$

$$\text{?} \text{indicates text missing or illegible when filed}$$

in which the deceleration manipulated variable u_{brake} denotes a braking deceleration brought about by active braking.

For the further calculations within the scope of this exemplary embodiment, it is assumed for simplicity that both the deceleration manipulated variable in drag mode a_{drag} and the deceleration manipulated variable during active braking u_{brake} are constant over time during the drag phase, respectively braking deceleration phase. This enables simple and particularly computationally efficient ascertaining of the reference trajectory through a parametric optimization with regard to the switching times. Cf. Xuping, Xu; Antsaklis, P. J.: Optimal Control of Switched Systems based on Parameterization of the Switching Instants. IEEE Transactions on Automatic Control, 2004.

It should however be borne in mind that a solution to the hybrid optimal control problem is also possible in principle without these simplifying assumptions with regard to the deceleration manipulated variables. However, in contrast, for an analytical solution, other approximations are then necessary, such as simplifying the cost function and linearizing the deceleration modes. A numerical solution leads to a boundary value problem that is able to be solved at best with a great deal of computational effort. Cf. Pakniyat, Ali; Caines, Peter E.: On the Hybrid Minimum Principle. IEEE Transactions on Automatic Control, 2020.

Working on the assumption of constant deceleration manipulated variables, it is possible to give, as analytical solutions to the differential equations given above for the sailing and drag phase, the following analytical functions for a respective speed and a respective distance traveled as a function of the time variable t:

$${s}_{sail} ( t ) = - \frac{1}{2 {a}_{air}} ln ( {tan ( {b}_{2} t + {c}_{1} )}^{2} + 1 ) + {c}_{2}$$

$${v}_{sail} ( t ) = {b}_{1} tan ( {b}_{2} t + {c}_{1} )$$

$${s}_{drag} ( t ) = - \frac{1}{2 {a}_{air}} ln ( {tan ( {b}_{4} t + {c}_{3} ( {t}_{{s}_{1}} ) )}^{2} + 1 ) + {c}_{4} ( {t}_{{s}_{1}} )$$

$${v}_{drag} ( t ) = {b}_{3} tan ( {b}_{4} t + {c}_{3} ( {t}_{{s}_{1}} ) )$$

In this case, the constant function parameters b₁, b₂, b₃, b₄ are derived as follows from the variables aₛₐᵢₗ, a_{drag} and aₐᵢᵣ introduced further above:

$${b}_{1} = \sqrt{\frac{{a}_{sail}}{{a}_{air}}}$$

$${b}_{2} = - \sqrt{{a}_{air} {a}_{sail}}$$

$${b}_{3} = \sqrt{\frac{{a}_{sail} + {a}_{drag}}{{a}_{air}}}$$

$${b}_{4} = - \sqrt{{a}_{air} ( {a}_{sail} + {a}_{drag} )}$$

The function parameters c₁ and c₂ are determined such that the starting condition xₛₐᵢₗ(0)=x₀ is satisfied. The function parameters c₃ and c₄ are determined from the continuity condition xₛₐᵢₗ(tₛ₁)=x_{drag}(tₛ₁).

With regard to the differential equation given above for x_{brake}, it is able to be mathematically proven that there is a real braking manipulated variable u_{brake} that the system converts, in a finite time t_{f}, into the desired end state with the target speed v_{f} and the target position s_{f}.

Specifically, the following analytical expressions arise for the end time tᵣ and the braking manipulated variable u_{brake}, which depend, in terms of parameters, on the changeover times tₛ₁, tₛ₂:

$${u}_{brake} ( {t}_{{s}_{1}} , {t}_{{s}_{2}} ) = \frac{{a}_{air} ( \text{?} ( {t}_{{s}_{2}} ) exp [ - 2 {a}_{air} ( \text{?} - \text{?} ( {t}_{{s}_{2}} ) ] - \text{?}}{1 - exp [ - 2 {a}_{air} ( \text{?} - \text{?} ( {t}_{{s}_{2}} ) ) ]} - {a}_{sail}$$

$${t}_{f} ( {t}_{{s}_{1}} , {t}_{{s}_{2}} ) = \frac{1}{\sqrt{{a}_{air} ( \text{?} + \text{?} )}} ( arctan ( \frac{{a}_{air} \text{?} ( \text{?} )}{\sqrt{{u}_{brake} + {a}_{sail}}} ) - arctan ( \frac{a \text{?}}{\sqrt{{u}_{brake} + {a}_{sail}}} ) )$$

$$\text{?} \text{indicates text missing or illegible when filed}$$

The following analytical functions may be given as an analytical solution to the differential equation given above for the braking phase:

$${s}_{brake} ( t ) = \frac{1}{2 {a}_{air}} ln ( {tan ( {b}_{6} t + {c}_{5} ( {t}_{{s}_{1}} , {t}_{{s}_{2}} ) )}^{2} + 1 ) + {c}_{6} ( {t}_{{s}_{1}} , {t}_{{s}_{2}} )$$

$${v}_{brake} ( t ) = {b}_{5} tan ( {b}_{6} t + {c}_{5} ( {t}_{{s}_{1}} , {t}_{{s}_{2}} ) )$$

In this case, the constant function parameters b₅ and b₆ depend on the variables aₛₐᵢₗ, aₐᵢᵣ and u_{brake} as follows:

$${b}_{5} = \sqrt{\frac{{a}_{sail} + {u}_{brake} ( {t}_{{s}_{1}} , {t}_{{s}_{2}} )}{{a}_{air}}}$$

$${b}_{6} = \sqrt{{a}_{air} ( {a}_{sail} + {u}_{brake} ( {t}_{{s}_{1}} , {t}_{{s}_{2}} )}$$

The other function parameters c₅ and c₆ are determined from the continuity condition x_{drag}(tₛ₂)=x_{brake}(tₛ₂).

Based on these preliminary observations, the cost function J may then be parameterized with regard to the changeover times tₛ₁ and tₛ₂:

$$J = \frac{1}{2} \int \text{?} w \text{?} {( {v}_{sail}^{2} ( t ) - v \text{?} )}^{2} dt + \frac{1}{2} {\int }_{{t}_{{s}_{1}}}^{{t}_{{s}_{2}}} ( w \text{?} {a}_{drag}^{2} + w \text{?} {( {a}_{drag}^{2} ( t ) - {v}_{0}^{2} )}^{2} ) dt + \frac{1}{2} \int \text{?} ( w \text{?} {u}_{brake}^{2} + w \text{?} {( {v}_{brake}^{2} ( t ) - {v}_{0}^{2} )}^{2} ) dt = J ( {t}_{{s}_{1}} , {t}_{{s}_{2}} )$$

$$\text{?} \text{indicates text missing or illegible when filed}$$

Proceeding from this, a parametric optimization problem for the transformed variables

$$Δ {t}_{sail} = {t}_{{s}_{1}} - {t}_{0}$$

$$Δ {t}_{drag} = {t}_{{s}_{2}} - {t}_{{s}_{1}}$$

may be formulated as follows:

$$\begin{matrix}{min}_{Δ {t}_{sail} , Δ {t}_{drag}} & J ( Δ {t}_{sail} , Δ {t}_{drag} ) \\ s . t . & {u}_{brake} ( Δ {t}_{sail} , Δ {t}_{drag} ) \leq {u}_{max} \\ & 0 \leq Δ {t}_{sail} \\ & 0 \leq Δ {t}_{drag}\end{matrix}$$

This parametric optimization problem is able to be solved numerically using computationally efficient standard methods, that is to say tₛ₁ and tₛ₂ are able to be determined numerically such that the cost function J is minimized. If the changeover times tₛ₁ and tₛ₂ are known, the desired reference trajectory is known based on the analytical expressions given above for path and speed in the three deceleration phases.

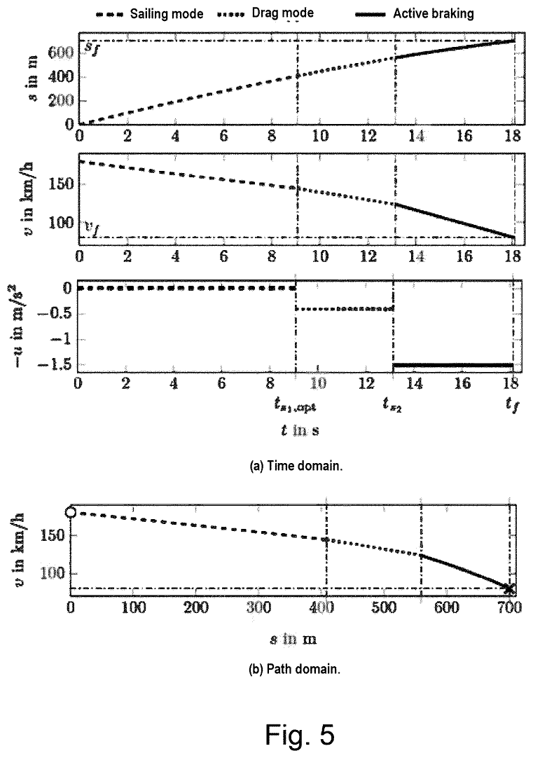

FIG. 5 illustrates a solution for the parameters s₀=0, v₀=180 km/h, s_{f}=700 m, v_{f}=80 km/h, α=2°, a_{drag}=0.4 m/s², wᵤ=1 and wₖᵢₙ=1e⁻⁶.

In this case, the upper three graphs (FIG. 5(a)) show profiles of path s in meters, speed v in km/h and the deceleration manipulated variable u in m/s² each as a function of time t in seconds. Two vertical dashed lines mark the optimal changeover times tₛ₁ (dashed line on the left) and tₛ₂ (dashed line on the right).

In the lower graph (FIG. 5(b)), speed v in km/h is plotted against path traveled s in meters, wherein two vertical dashed lines mark the positions at which the vehicle 1 will be at the changeover times tₛ₁ and tₛ₂.

The reference trajectory planning thus decides, in this exemplary embodiment, that it is optimal to sail for approximately the first 410 m, and then to drag for approximately 150 m, and finally to actively brake the last approximately 140 m safely and comfortably with a deceleration of approximately 1.5 m/s² in order to accurately comply with the new speed limit of 80 km/h.

If the magnitude of the braking deceleration u_{brake} is fixedly specified from the outset, it is possible to further reduce the required computing time to a great extent by reducing the optimization problem to a parametric one-dimensional optimization. Working on this assumption concerning the braking deceleration u_{brake}, it is possible to eliminate one free variable and for example to express the second changeover time tₛ₂ as a function of the first changeover time tₛ₁, that is to say tₛ₂=tₛ₂(tₛ₁). The optimization problem may then be formulated as follows:

$$\begin{matrix}{min}_{{t}_{{s}_{1}}} & J ( {t}_{{s}_{1}} ) \\ s . t . & 0 \leq Δ {t}_{{s}_{1}} \leq {t}_{{s}_{1} , max}\end{matrix}$$

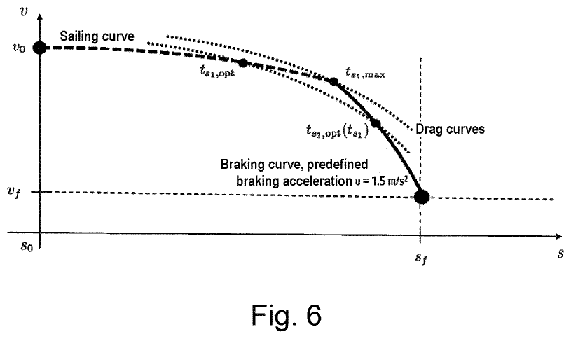

FIG. 6 graphically illustrates, with reference to a speed/path graph for the reference trajectory to be ascertained, how, in the case of a fixedly specified braking deceleration u_{brake} (here: u_{brake}=1.5 m/s²), it is possible to determine an upper limit t_{s1,max} for the first changeover time and the desired optimal first and second changeover times t_{s1,opt} and t_{s2,opt}(tₛ₁) from the known curve profiles for the path-dependent speeds v(s) in the three deceleration phases. In this case, t_{s1,max} arises as the point of intersection between the speed curve starting at the starting position so with the starting speed v₀ for sailing mode (dashed curve in FIG. 6) and the speed curve ending at the target position s_{f} with the target speed v_{f} for active braking mode (unbroken curve in FIG. 6). The optimal first changeover time t_{s1,opt} may then be determined with little numerical computational effort or even analytically as a solution to the one-dimensional optimization problem given above. Finally, the optimal second changeover time t_{s2,opt} arises as the point of intersection between the speed curve for drag mode (lower dashed curve in FIG. 6) that intersects the speed curve for sailing mode at the optimal first changeover time t_{s1,opt} and the speed curve for active braking mode.

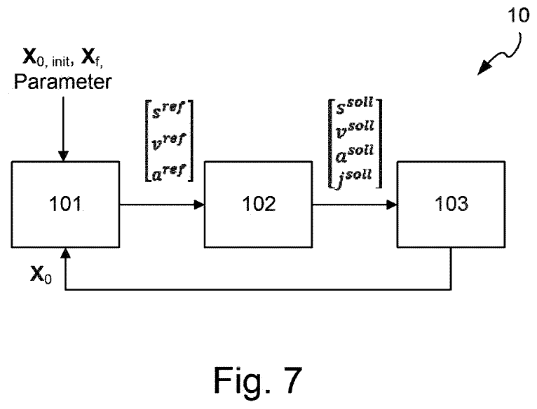

FIG. 7 shows, by way of example and schematically, a system 10 for controlling the longitudinal guidance of a vehicle, such as the vehicle 1. The system 10 comprises a reference trajectory planner 101, a target trajectory planner 102 and a control loop 103.

The reference trajectory planner 101 is configured, in the manner described above, to ascertain a reference trajectory for decelerating the vehicle 1 to a target speed v₁ at a target position sᵣ as a solution to a hybrid optimal control problem as a function of an initial starting state x₀, a target state x₁ and other parameters (for example concerning driving resistances). The reference trajectory indicates a respective temporal profile of a reference path s^{ref}, a reference speed v^{ref} and a reference acceleration a^{ref}. A temporal planning horizon of the reference trajectory planner 101 extends from the starting time to up to the end time tᵣ, at which the vehicle 1 will reach the target position s₁ in accordance with the reference trajectory.

The target trajectory planner 102 is configured, as a function of the reference trajectory, to plan a target trajectory that indicates a respective profile of a target path s^{soll}, a target speed v^{soll}, a target acceleration a^{soll} and a target jerk j^{soll}. The target trajectory may be ascertained for example as part of a model predictive control process by way of a quadratic optimization with regard to further criteria, concerning for example safety and comfort. In this case, a temporal planning horizon of the target trajectory planner 102 may extend in each case over a few seconds, such as 6 seconds, into the future. N interpolation points may be provided for the target trajectory planning at shorter time intervals of for example 0.2 seconds, in a manner distributed across the planning horizon.

The reference trajectory may be taken into consideration as a reference when calculating the target trajectory. By way of example, in the optimization, the variables s, v, a and j may be determined so as to minimize the following cost function:

$$J = {\sum }_{k = 0}^{N} l ( k )$$

$$l ( k ) = {{w}_{s} ( s - {s}^{ref} )}^{2} + {{w}_{v} ( v - {v}^{ref} )}^{2} + {{w}_{a} ( a - {a}^{ref} )}^{2} + {w}_{j} {j}^{2} + {w}_{u} {u}^{2}$$

where k is an index for a respective interpolation point along the planning horizon of the target trajectory planner 102.

It is also possible to link the target trajectory planning to the reference trajectory planning in such a way that the time-dependent speed profile v^{ref} in accordance with the reference trajectory represents an upper limit vₘₐₓ in the course of the optimization in order to determine the target speed v^{soll}. According to one variant embodiment, the upper limit does not have to be a hard limit here, but rather may be softened for example by way of a slack variable ε_{v,max}. In this variant embodiment, the cost function to be minimized, together with the softened restriction for the speed, may be given for example as follows:

$$J = {\sum }_{k =}^{N} \text{?} l ( k )$$

$$l ( k ) = - w \text{?} s + {w}_{a} {a}^{2} + {w}_{j} {j}^{2} + {w}_{u} {u}^{2}$$

$$0 \leq v \leq {v}_{max} + {ϵ}_{v , max}$$

$$\text{?} \text{indicates text missing or illegible when filed}$$

As a further possible alternative, the reference acceleration may be used as a lower limit amin for the target acceleration to be determined, wherein, according to one variant embodiment, the restriction may be softened by way of a slack variable ε_{v,min}. In this variant embodiment, the cost function to be minimized, together with the softened restriction for the acceleration, may be given for example as follows:

$$J = {\sum }_{k = 0}^{N} l ( k )$$

$$l ( k ) = w \text{?} s + {{w}_{v} ( v - v \text{?} )}^{2} + {w}_{a} {a}^{2} + {w}_{j} {j}^{2} + {w}_{u} {u}^{2}$$

$${a}_{min} - {ϵ}_{v , min} \leq a$$

$$\text{?} \text{indicates text missing or illegible when filed}$$

The control loop 103 comprises a longitudinal guidance actuator system, such as a drive and a braking system, of the vehicle 1. By way of example, in the course of the control loop 103, the target acceleration a^{soll} may be used as an actuator input for the longitudinal guidance actuator system. However, it is also possible for the control loop to comprise one or more controllers subordinate to the trajectory planning, such as a trajectory follow-up controller, which generate a specific actuator input for the longitudinal guidance actuator system as a function of the target trajectory and of information about current measured interfering variable influences, for instance in the form of a specification of a drive torque to be implemented by the longitudinal guidance actuator system or an acceleration to be implemented by the longitudinal guidance actuator system.

In this case, the system 10 carries out the longitudinal guidance control cyclically by feeding back in each case a current state (for example, measured by way of an odometer), such as a current actual speed or a current actual acceleration or an actual distance traveled, to the reference trajectory planner 101. This may then calculate a respective updated reference trajectory with the fed-back current state x₀ as a starting state.

1.-13. (canceled)

14. A method for determining a deceleration strategy for a vehicle, the method comprising:
determining a target position that lies on a route section ahead of the vehicle together with a target speed at which the vehicle should be when reaching the target position, wherein the target speed is less than a current speed of the vehicle; and
determining a reference trajectory for the vehicle that makes provision to reach the target position at the target speed,
wherein the reference trajectory is determined based on analytical functions for at least two deceleration modes from a list including
a sailing mode,
a drag mode,
a recuperation mode, and
active braking,
wherein the analytical functions for each of the at least two deceleration modes indicate a speed and/or a distance traveled as a function of a time variable, and
wherein determining the reference trajectory includes determining one or more changeover times between the at least two deceleration modes based on the analytical functions.

15. The method according to claim 14, wherein the analytical functions are closed mathematical expressions with the time variable and multiple function parameters that characterize one or more types of driving resistances.

16. The method according to claim 15, wherein the multiple function parameters comprise one or more deceleration manipulated variables for one or more of the at least two deceleration modes.

17. The method according to claim 14, wherein one or more of the analytical functions that indicate distance traveled as a function of the time variable for the at least two deceleration modes are given in a following relationship:
$$s ( t ) = A ln ( {tan ( B t + C )}^{2} + 1 + D ,$$
where s is distance, t is the time variable and A, B, C and D are constant function parameters.

18. The method according to claim 15, wherein one or more of the analytical functions that indicate distance traveled as a function of the time variable for the at least two deceleration modes are given in a following relationship:
$$s ( t ) = A ln ( {tan ( B t + C )}^{2} + 1 + D ,$$
where s is distance, t is the time variable and A, B, C and D are constant function parameters.

19. The method according to claim 16, wherein one or more of the analytical functions that indicate distance traveled as a function of the time variable for the at least two deceleration modes are given in a following relationship:
$$s ( t ) = A ln ( {tan ( B t + C )}^{2} + 1 + D ,$$
where s is distance, t is the time variable and A, B, C and D are constant function parameters.

20. The method according to claim 14, wherein one or more of the analytical functions that indicate speed as a function of the time variable for the at least two deceleration modes are given in a following relationship:
$$v ( t ) = E tan ( F t + G ) ,$$
where v is speed, t is the time variable and E, F and G are constant function parameters.

21. The method according to claim 15, wherein one or more of the analytical functions that indicate speed as a function of the time variable for the at least two deceleration modes are given in a following relationship:
$$v ( t ) = E tan ( F t + G ) ,$$
where v is speed, t is the time variable and E, F and G are constant function parameters.

22. The method according to claim 16, wherein one or more of the analytical functions that indicate speed as a function of the time variable for the at least two deceleration modes are given in a following relationship:
$$v ( t ) = E tan ( F t + G ) ,$$
where v is speed, t is the time variable and E, F and G are constant function parameters.

23. The method according to claim 17, wherein one or more of the analytical functions that indicate speed as a function of the time variable for the at least two deceleration modes are given in a following relationship:
$$v ( t ) = E tan ( F t + G ) ,$$
where v is speed, t is the time variable and E, F and G are constant function parameters.

24. The method according to claim 14,
wherein the one or more changeover times are determined based on minimizing a cost function,
wherein the cost function comprises a sum of multiple time integrals,
wherein each of the multiple time integrals extends temporally over a respective deceleration phase that is assigned to a respective one of the at least two deceleration modes,
wherein the one or more changeover times form upper or lower integral bounds of the integrals, and
wherein the cost function under the multiple time integrals for the at least two deceleration phases has a respective time-dependent cost term that applies costs to a loss of kinetic energy that has taken place up to a first time in comparison to an initial kinetic energy that the vehicle has at a start of the deceleration.

25. The method according to claim 15,
wherein the one or more changeover times are determined based on minimizing a cost function,
wherein the cost function comprises a sum of multiple time integrals,
wherein each of the multiple time integrals extends temporally over a respective deceleration phase that is assigned to a respective one of the at least two deceleration modes,
wherein the one or more changeover times form upper or lower integral bounds of the integrals, and
wherein the cost function under the multiple time integrals for the at least two deceleration phases has a respective time-dependent cost term that applies costs to a loss of kinetic energy that has taken place up to a first time in comparison to an initial kinetic energy that the vehicle has at a start of the deceleration.

26. A method for determining a deceleration strategy for a vehicle, the method comprising:
determining a target position that lies on a route section ahead of the vehicle together with a target speed at which the vehicle should be when reaching the target position, wherein the target speed is less than a current speed of the vehicle; and
determining a reference trajectory for the vehicle that makes provision to reach the target position at the target speed,
wherein the reference trajectory has at least two deceleration phases in which the vehicle is operated in each case in a different deceleration mode from a list including
a sailing mode,
a drag mode,
a recuperation mode, and
active braking,
wherein the determining the reference trajectory includes determining one or more changeover times between the at least two deceleration modes,
wherein the one or more changeover times are determined based on minimizing a cost function,
wherein the cost function comprises a sum of multiple time integrals,
wherein each of the multiple time integrals extends temporally over a respective one of the deceleration phases,
wherein the one or more changeover times form upper or lower integral bounds of the multiple time integrals, and
wherein the cost function under the multiple time integrals for the at least two deceleration phases has a respective time-dependent cost term that applies costs to a loss of kinetic energy that has taken place up to a first time in comparison to an initial kinetic energy that the vehicle has at a start of the deceleration.

27. The method according to claim 26, wherein the time-dependent cost term comprises a square of a difference between a kinetic energy at the first time and the initial kinetic energy.

28. The method according to claim 26, wherein, for purposes of the determining of the reference trajectory, one or more deceleration manipulated variables that are active in the at least two deceleration modes are assumed to be constant over time during a respective deceleration phase in which a respective deceleration mode is active.

29. The method according to claim 27, wherein, for purposes of the determining of the reference trajectory, one or more deceleration manipulated variables that are active in the at least two deceleration modes are assumed to be constant over time during a respective deceleration phase in which a respective deceleration mode is active.

30. The method according to claim 26, wherein the reference trajectory has a sailing phase, in which the vehicle drives in sailing mode, and after the sailing phase at least one further deceleration phase, in which the vehicle drives in drag mode or recuperation mode or is actively braked.

31. The method according to claim 26, further comprising:
determining a target trajectory for the vehicle in dependence on the reference trajectory; and
generating an actuator input for longitudinal guidance of the vehicle in dependence on the target trajectory.

32. A data processing device configured to carry out a method according to claim 14.

33. A data processing device configured to carry out a method according to claim 26.

34. A non-transitory computer-readable medium storing commands that, when executed by a data processing device, cause the data processing device to carry out a method according to claim 14.

35. A non-transitory computer-readable medium storing commands that, when executed by a data processing device, cause the data processing device to carry out a method according to claim 26.
